(19) United States
(12) Patent Application Publication
(10) Pub. No.: US 2025/0166194 A1
(43) Pub. Date: May 22, 2025

(54) OPTIMIZED ORGAN IMAGE PROCESSING USING AI

(71) Applicant: GE Precision Healthcare LLC, Waukesha, WI (US)

(72) Inventors: Hongxu Yang, Helmond (NL); Xiaomeng Dong, San Ramon, CA (US); Pál Tegzes, Budapest (HU); Lehel Mihály Ferenczi, Budapest (HU); Gopal Biligeri Avinash, Concord, CA (US); Yunfeng Li, New Berlin, WI (US); Michail Fanariotis, Skien (NO)

(21) Appl. No.: 18/951,587

(22) Filed: Nov. 18, 2024

Related U.S. Application Data
(60) Provisional application No. 63/601,479, filed on Nov. 21, 2023.

(51) Int. Cl. G06T 7/00; G06T 5/60; G06V 10/82

(52) U.S. Cl. CPC G06T 7/0014; G06T 5/60; G06V 10/82; G06T 2207/10072

(57) ABSTRACT

A technique to optimize medical image enhancement that is facilitated by AI/deep learning neural network implementation. In various embodiments, the computer-executable components can comprise a receiving component that receives a set of “regions/volume of interest” images containing a plurality of organs; and an artificial intelligence deep learning neural network model component that automatically processes and enhances the respective images in a locally adaptive way so that at each location the enhanced image is optimized for the organ that is displayed at that location.

### RELATED APPLICATION

This application claims priority to U.S. Provisional Patent Application No. 63/601,479, filed Nov. 21, 2023, and entitled “OPTIMIZED ORGAN IMAGE PROCESSING USING AI”, the entirety of which is incorporated herein by reference.

### TECHNICAL FIELD

The subject disclosure relates generally to an automated artificial intelligence (AI) solution for contrast enhancement for organs and body regions, such as e.g., computed tomography (CT) images with or without intravenous contrast agent injection.

### BACKGROUND

When given a medical image, it can be difficult for medical personnel to understand clear implications of the image if areas of interest are not granular or distinct. Contrast in medical images is desired for accurate diagnosis and interpretation. However, there can be issues related to contrast in medical images that can impact quality and reliability of diagnostic information. Brightness in medical images, like contrast, plays a significant role in diagnostic interpretation. Issues related to brightness can impact visibility and interpretation of structures, potentially affecting accuracy of diagnosis.

### SUMMARY

The following presents a summary to provide a basic understanding of one or more embodiments of the invention. This summary is not intended to identify key or critical elements or delineate any scope of particular embodiments or any scope of associated claims. Its sole purpose is to present concepts in a simplified form as a prelude to the more detailed description that is presented later. In one or more embodiments described herein, devices, systems, computer-implemented methods, apparatus or computer program products that facilitate improved deep learning image processing are described.

CT images, such as molecular imaging computed tomography (MICT), have been used in many different diagnostic applications as a result of its capacity to enhance organ or tumor appearance in scanning across different phase(s) of pharmacokinetics. However, automated raw images provide a general look by default, which often requires different pre-settings/reconstructions/scanning of brightness and contrast to enhance organ(s)/region(s) of interest. For example, lung and bones can have different preferred visualization settings/reconstruction for optimized visualization(s). Therefore, in a situation where a radiologist desires to check different organs or regions, multiple image reconstruction and manipulating between different views are needed. Oftentimes clinicians need to rely upon their imagination to mentally generate compounded and combined images in their mind.

To accelerate visualization for optimizing CT images for different organs and regions, an automated image enhancement method is needed. An embodiment is an AI-based technique for CT image enhancement. The technique can automatically optimize contrast of organ(s) for different preferred views while still preserving structures and details within the image. The innovation provides a seamless optimization solution for CT image diagnosis. Advantageously, efforts and expenses for multi-region analysis in 2D/3D/4D images are drastically reduced. The innovation can reduce a radiologist's image reviewing effort for different organs, and/or tumors with an automated AI-based solution. The innovation provides an approach to reduce complexity for image manipulation among different views.

Overall, a region based automated image contrast enhancement technique can provide optimized automated AI-based CT image enhancement. The innovation is a fully automated solution so there is no need to obtain organ masks a priori to select regions of interest (ROI) for respective brightness and contrast manipulation. Preserved results are smooth and anatomically precise thanks to end-to-end training with a remapping algorithm, and obtained images are smooth at region transitions and can preserve details of structure with significant improvement over that can be achieved conventionally, e.g., with a commonly used image-to-image translation algorithm. This will ease the burden of radiologist(s)/clinician(s) fusing different organs mentally from multiple images. A final output of the AI model generates composite images with corresponding varied desired/optimal regional enhancements; therefore, users can avoid tedious image adjustment for day-to-day diagnostic work. It's easy to train clinicians on this usage, this innovation is intuitive for clinicians to learn underlying concepts and radiologic features. Overall, it's reasonably easy to train as this innovation, and requires lesser effort for annotation and training compared to conventional methods employed for achieving similar results. Results are easier to maintain compared to conventional tools, e.g., with a complex segmentation model(s); the innovation is simple and easy to train and maintain, to make changes, or for fine-tuning.

According to one or more embodiments, a system is provided. The system can comprise a non-transitory computer-readable memory that can store computer-executable components. The system can further comprise a processor that can be operably coupled to the non-transitory computer-readable memory and that can execute the computer-executable components stored in the non-transitory computer-readable memory. In various embodiments, the computer-executable components can comprise a receiving component that receives a set of “regions/volume of interest” images containing a plurality of organs; and an artificial intelligence deep learning neural network model component that automatically processes and enhances the respective images in a locally adaptive way so that at each location the enhanced image is optimized for the organ that is displayed at that location.

In another embodiment, a computer-implemented method, comprising, receiving, by a device operatively coupled to a processor, a set of “regions/volume of interest” images containing a plurality of organs; and employing an artificial intelligence deep learning neural network model that automatically processes and enhances the respective images in a locally adaptive way so that at each location the enhanced image is optimized for the organ that is displayed at that location.

In yet another embodiment, a computer program product for facilitating automatic organ image enhancement, the computer program product comprising a non-transitory computer-readable memory having program instructions embodied therewith, the program instructions executable by a processor to cause the processor to receive, by a device operatively coupled to a processor, a set of “regions/volume of interest” images containing a plurality of organs; and employ by the processor, an artificial intelligence deep learning neural network model that automatically processes and enhances the respective images in a locally adaptive way so that at each location the enhanced image is optimized for the organ that is displayed at that location.

According to one or more embodiments, the above-described system can be implemented as a computer-implemented method or a computer program product.

### DESCRIPTION OF THE DRAWINGS

FIG. 1 illustrates a block diagram of an example, non-limiting system that facilitates enhanced image processing in accordance with one or more embodiments described herein.

FIG. 2 illustrates an example of various images with different brightness and contrast in accordance with one or more embodiments described herein.

FIG. 3 illustrates an example of the image optimization process in accordance with one or more embodiments described herein.

FIG. 4 illustrates an example, non-limiting block diagram showing how a deep learning neural network can be trained on a training dataset with reference to ground truth in accordance with one or more embodiments described herein.

FIGS. 5-7B illustrates examples of current segmentation-based images versus images processed by the invention in accordance with one or more embodiments described herein.

FIG. 8 illustrates a flow diagram of an example non-limiting computer-implemented method that facilitates enhanced image processing in accordance with one or more embodiments described herein.

FIG. 9 illustrates an example of the image optimization process using text as prompt to guide the feature decoding in accordance with one or more embodiments described herein.

FIG. 10 illustrates a block diagram of an example, non-limiting operating environment in which one or more embodiments described herein can be facilitated.

FIG. 11 illustrates an example networking environment operable to execute various implementations described herein.

### DETAILED DESCRIPTION

The following detailed description is merely illustrative and is not intended to limit embodiments or application/uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of one or more embodiments. It is evident, however, in various cases, that one or more embodiments can be practiced without these specific details.

Medical imaging plays a significant role in modern healthcare, and is integral to diagnosis, treatment, and monitoring of various medical conditions. Here are some reasons why imaging is important in the medical field: for diagnosis medical imaging techniques, such as X-rays, CT scans, MRI, ultrasound, and nuclear medicine, it allows healthcare professionals to visualize internal structures and organs. This visualization helps in accurate diagnosis of a wide range of medical conditions, including fractures, tumors, infections, and cardiovascular diseases. For patient treatment planning imaging provides essential information for planning and guiding medical interventions and surgeries. Surgeons can use pre-operative imaging to understand anatomy of an area they will be operating on, leading to more precise and effective procedures. Also, medical imaging is important for monitoring progression of diseases and assessing effectiveness of treatments. It allows healthcare providers to track changes in size and characteristics of tumors, evaluate status of organs, and adjust treatment plans accordingly. In some cases, medical imaging enables early detection of diseases before symptoms manifest. Early diagnosis often leads to more successful treatment outcomes and can significantly improve a patient's prognosis.

Other areas impacted are research and education. Medical imaging is essential for medical research, allowing scientists and healthcare professionals to study diseases, develop new treatment methods, and enhance understanding of human anatomy and physiology. It is also a valuable tool in medical education for training future healthcare professionals. In emergency situations, rapid and accurate diagnosis is very important and imaging techniques, such as X-rays and CT scans, play a substantial role in quickly assessing injuries and determining appropriate course of action. Non-invasive assessment is also an area where medical imaging can provide a non-invasive technique to visualize internal structures of a body, reducing need for exploratory surgeries; this can minimize patient discomfort, shorten recovery time, and lower healthcare costs. Overall, medical imaging has revolutionized healthcare by providing valuable insights into the human body's structure and function. Advances in imaging technology continue to enhance diagnostic capabilities, improve treatment strategies, and ultimately contribute to better patient outcomes.

While use of contrast agents in medical imaging can significantly enhance visualization of organs and structures, there are potential image quality issues that can arise. It's important for healthcare professionals to be aware of these issues to ensure accurate interpretation of contrast-enhanced images. Some common image quality concerns include artifacts which are unwanted features or distortions in images that can arise from various sources, including patient motion, metallic implants, or issues related to contrast injection. Artifacts can degrade image quality and affect accuracy of interpretation. Inadequate contrast enhancement where a contrast agent does not provide sufficient enhancement of a target organ or lesion could be due to factors such as insufficient contrast dose, improper injection technique, or physiological variations in a patient. Timing issues associated with trying to achieve optimal contrast enhancement often requires precise timing of contrast injection relative to imaging acquisition. Variations in circulation time and injection rate can impact quality of enhancement and lead to suboptimal images. Some patients may experience allergic reactions to contrast agents. Although these reactions are relatively rare, they can range from mild to severe and may impact an imaging procedure.

Healthcare providers need to be vigilant in monitoring patients for signs of allergic responses. Contrast-induced nephropathy is a potential concern, particularly with iodine-based contrast agents used in CT imaging. Patients with impaired renal function may be at risk, and healthcare professionals carefully assess risk-benefit ratio of using contrast in such cases. Another concern is that some lesions or tissues may exhibit heterogeneous enhancement patterns, making it challenging to interpret images accurately. Radiologists need to consider the possibility of varying enhancement within the same organ or lesion. Variability in patient characteristics, such as body habitus, can affect distribution of contrast agents and, consequently, image quality. Special considerations may be needed for pediatric or obese patients. Issues with imaging equipment or technical parameters can impact image quality. Regular quality assurance checks and calibration are essential to ensure optimal performance. Post-processing of contrast-enhanced images may introduce artifacts. Radiologists need to be aware of potential artifacts and carefully review images to distinguish between true pathology and artifacts. Integrating contrast-enhanced images with non-contrast images or images from other modalities can sometimes be challenging. Co-registration issues may affect accurate correlation of findings. Efforts are continually made to address and mitigate these image quality issues. Radiologists and imaging technologists undergo training to optimize imaging protocols, minimize artifacts, and interpret images accurately. Additionally, advancements in technology and the development of newer contrast agents aim to improve the overall quality and safety of contrast-enhanced imaging.

A novelty of this innovation is that it's an AI based CT image enhancement technique for different organs/ROIs, which assigns preferred brightness and contrast automatically to provide consistent and good interpretation of organ(s), outlines, edges and transition areas. The innovation has automated organ-specific brightness and contrast enhancement derived from training using initial segmentation. The innovation provides an automated enhancement for different ROIs, therefore, provides respective organ-specific optimized view of input images.

The advantages of neural networks are utilized for enhancement via a fully AI-based approach; therefore, the organs/ROI edges are more smooth and consistent because of features of the neural network and extensive training. The innovation is based on a previously proposed invention, so-called remapping algorithm, that could predict window level (WL) and window width (WW) maps, rather than direct image-to-image translation. Therefore, the automated adjusted WW/WL can be obtained and analyzed from maps, therefore the AI results can be interpreted by clinicians easier.

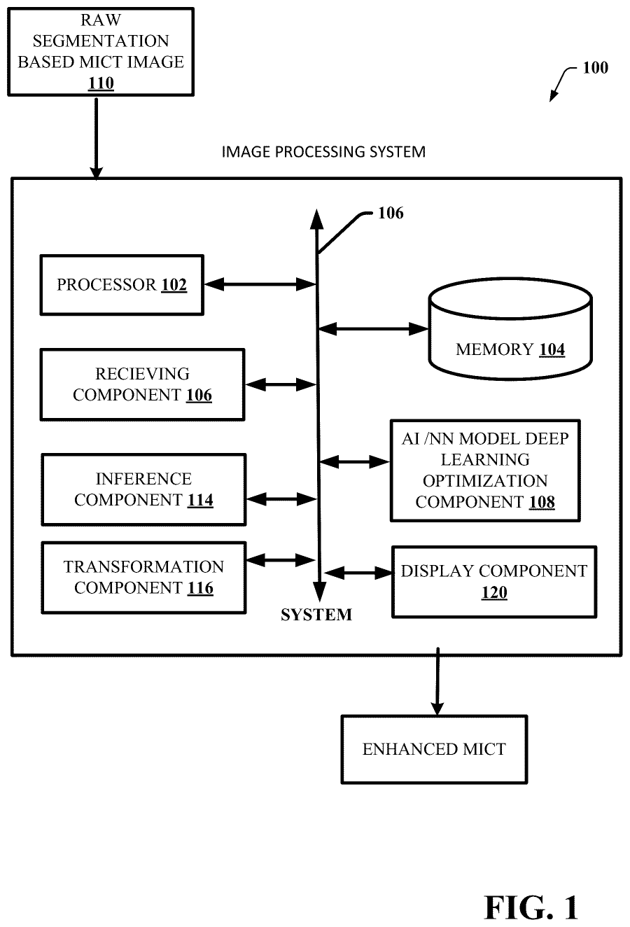

FIG. 1 illustrates a block diagram of an example, non-limiting system 100 that can facilitate improved deep learning image processing in accordance with one or more embodiments described herein. As shown, an image processing system 100 can be electronically integrated, via any suitable wired or wireless electronic connection, with a medical image 110. In various embodiments, the medical image 110 can depict any suitable anatomical structure of any suitable medical patient. As some non-limiting examples, the anatomical structure can be any suitable tissue of the medical patient (e.g., bone tissue, lung tissue, muscle tissue, brain tissue), any suitable organ of the medical patient (e.g., heart, liver, lung, brain, eye, colon, blood vessel), any suitable bodily fluid of the medical patient (e.g., blood, amniotic fluid), any other suitable body part of the medical patient, or any suitable portion thereof.

In various aspects, the medical image 110 can exhibit any suitable format, size, or dimensionality. As a non-limiting example, the medical image 110 can be an x-by-y array of pixels, for any suitable positive integers x and y. As another non-limiting example, the medical image 104 can be an x-by-y-by-z array of voxels for any suitable positive integers x, y, and z.

In various instances, the medical image 110 can be generated or otherwise captured by any suitable medical imaging device, medical imaging equipment, or medical imaging modality (not shown). As a non-limiting example, the medical image 110 can be generated or otherwise captured by a CT scanner, in which case the medical image 110 can be considered as a CT scanned image. As another non-limiting example, the medical image 110 can be generated or otherwise captured by an MRI scanner, in which case the medical image 110 can be considered as an MRI scanned image. As yet another non-limiting example, the medical image 110 can be generated or otherwise captured by a PET scanner, in which case the medical image 110 can be considered as a PET scanned image. As still another non-limiting example, the medical image 110 can be generated or otherwise captured by an X-ray scanner, in which case the medical image 110 can be considered as an X-ray scanned image. As even another non-limiting example, the medical image 110 can be generated or otherwise captured by an ultrasound scanner, in which case the medical image 110 can be considered as an ultrasound scanned image. Moreover, the medical image 110 can undergo any suitable image reconstruction techniques, such as filtered back projection.

In various embodiments, the medical image 110 can be considered as being made up of a plurality of regions. In other words, the pixels or voxels of the medical image 110 can be considered being assigned, allocated, or otherwise divvied up among the plurality of regions, such that each region can be considered as a subset of the pixels or voxels of the medical image. In various aspects, each pixel or voxel can be assigned to one and only one of the plurality of regions. Moreover, in various instances, each region can have two or more pixels or voxels assigned to it. Therefore, the cardinality of the plurality of regions can be lesser than the cardinality of the pixels or voxels in the medical image 110. In other words, there can be fewer regions than pixels or voxels.

In various embodiments, the image processing system 100 can comprise a processor 102 (e.g., computer processing unit, microprocessor) and a non-transitory computer-readable memory 104 that is operably or operatively or communicatively connected or coupled to the processor 102. The non-transitory computer-readable memory 104 can store computer-executable instructions which, upon execution by the processor 102, can cause the processor 102 or other components of the image processing system 100 (e.g., receiving component 106, AI model optimization component 108) to perform one or more acts. In various embodiments, the non-transitory computer-readable memory 104 can store computer-executable components (e.g., receiving component 106, AI model optimization component, and the processor 102 can execute the computer-executable components.

In various embodiments, the image processing system 100 can comprise a receiving component 106. In various aspects, the receiving component 106 can electronically receive a set of “regions/volume of interest” images containing a plurality of organs or otherwise electronically access the regions or medical image 110. In various instances, the receiving component 106 can electronically retrieve the medical image 110 from any suitable centralized or decentralized data structures (not shown) or from any suitable centralized or decentralized computing devices (not shown). As a non-limiting example, whatever medical imaging device, equipment, or modality (e.g., CT scanner, MRI scanner, X-ray scanner, PET scanner, ultrasound scanner) that generated or captured the medical image 110 can transmit the medical image 110 to the receiving component 106. In any case, the receiving component 106 can electronically obtain or access the medical image 110, such that other components of the image processing system 100 can electronically interact with the medical image 110.

In various embodiments, the image processing system 102 can comprise an AI model optimization component 108. In various aspects, as described herein, an artificial intelligence deep learning neural network model component that automatically processes and enhances the respective images in a locally adaptive way so that at each location the enhanced image is optimized for the organ that is displayed at that location and can execute a deep learning neural network on the medical image 110.

Various embodiments described herein can be considered as a computerized tool (e.g., any suitable combination of computer-executable hardware or computer-executable software) that can facilitate improved deep learning image processing. In various aspects, such computerized tool can comprise an access component, an inference component, a transformation component, or a display component.

In various embodiments, the medical image can depict one or more anatomical structures (e.g., tissues, organs, body parts, or portions thereof) of a medical patient (e.g., human, animal, or otherwise). In various instances, the medical image can exhibit any suitable size, format, or dimensionality (e.g., can be a two-dimensional pixel array, can be a three-dimensional voxel array). In various cases, the medical image can be generated or otherwise captured by any suitable medical imaging modality (e.g., by a CT scanner, by an MRI scanner, by an X-ray scanner, by a PET scanner, or by an ultrasound scanner). In various aspects, the medical image can have undergone any suitable image reconstruction technique (e.g., filtered back projection).

In any case, the pixels or voxels of the medical image can be considered as being allocated, divided, or otherwise assigned respectively among a plurality of regions. In various aspects, each given pixel or voxel of the medical image can be assigned to only one of the plurality of regions. Moreover, in various instances, each given region can have two or more pixels or voxels assigned to it. Accordingly, the total number of regions can be lesser than the total number of pixels or voxels in the medical image. In other words, each of the plurality of regions can be a strict subset of the pixels or voxels of the medical image, with each strict subset having a cardinality greater than one, and where such strict subsets are disjoint (e.g., non-overlapping) with each other.

In various aspects, a region of the medical image can be considered as any suitable contiguous cluster of pixels or voxels. That is, more than one pixel or voxel can be assigned to that region, and any two pixels or voxels that are assigned to that region can be either: adjacent to each other (e.g., within one row and one column of each other); or coupled to each other by an unbroken chain of other pixels or voxels, where every pixel or voxel of such unbroken chain is also assigned to that region, and where each consecutive pair of pixels or voxels in such unbroken chain are adjacent to each other. In various other aspects, a region of the medical image can be non-contiguous. That is, a region can be considered as comprising two or more distinct contiguous clusters of pixels or voxels, which two or more distinct contiguous clusters are spatially apart or otherwise not touching each other. In other words, there can be two pixels or voxels assigned to that region, where such two pixels or voxels are: not adjacent to each other; and not coupled to each other by any unbroken chain of other consecutively adjacent pixels or voxels that are also assigned to that region. In various cases, some of the plurality of regions can be contiguous while others of the plurality of regions can be non-contiguous.

In various aspects, a region of the medical image can exhibit any suitable shape (if the region is contiguous) or shapes (if the region is non-contiguous). For instance, a region can include more than one pixel or voxel of the medical image, which more than one pixel or voxel can collectively form (due to their spatial positions or locations within the medical image) any suitable regular or convex polygonal shape (e.g., square, rectangle). In other instances, a region can include more than one pixel or voxel of the medical image, which more than one pixel or voxel can collectively form (due to their spatial positions or locations within the medical image) any suitable irregular or non-convex polygonal shape. In various cases, different regions can have the same or different shapes as each other.

In various aspects, a region can be defined by any suitable interval or bin of pixel or voxel intensity values. For example, for any suitable positive real numbers a<b<c, all pixels of the medical image that have an intensity value greater than or equal to a and less than b can belong to one region of the plurality of regions, and all pixels of the medical image that have an intensity value greater than or equal to b and less than c can belong to another region of the plurality of regions. In various cases, different regions can be defined by different, distinct, disjoint, or otherwise non-overlapping intensity intervals or bins.

In various aspects, a region can be defined or otherwise based on a type of tissue that is depicted in the medical image. For example, suppose that the medical image illustrates d unique types of tissue (e.g., bone tissue, lung tissue, skin tissue, skeletal muscle tissue, cardiac muscle tissue) for any suitable positive integer d>1. In such case, the plurality of regions can comprise d+1 regions: one unique region for each of such d unique types of tissue, and one unique region for all pixels or voxels that belong to none of such d unique types of tissue. In various instances, such d unique types of tissue can be identified in any suitable fashion. For example, in some cases, a pre-trained tissue segmentation model can be executed on the medical image, and such pre-trained tissue segmentation model can produce as output a segmentation mask that indicates which pixels or voxels of the medical image belong to which of the d unique types of tissue.

No matter their shapes, no matter their contiguities, and no matter how they are otherwise defined (e.g., based on intensity bins or tissue types), the plurality of regions can be considered as collectively forming the medical image. In other words, the union of the plurality of regions can be equal to the medical image. In still other words, the plurality of regions can fit together like the pieces of a jigsaw puzzle to collectively yield the medical image.

In various embodiments, a receiving component 106 of a system 100 can electronically receive or otherwise electronically access a medical image 110. In some aspects, the receiving component 106 can electronically retrieve the medical image 110 from any suitable centralized or decentralized data structures (e.g., graph data structures, relational data structures, hybrid data structures), whether remote from or local to the receiving component 106. For example, the receiving component 106 can retrieve the medical image 110 from whatever medical imaging device generated or captured the medical image. In any case, the receiving component 106 can electronically obtain or access the medical image 110, such that other components of a computerized tool can electronically interact with (e.g., read, write, edit, copy, manipulate) the medical image 110.

In various embodiments, an inference component 114 of the system can electronically store, maintain, control, or otherwise access a deep learning neural network. In various instances, a deep learning neural network can exhibit any suitable internal architecture. For example, a deep learning neural network can include any suitable numbers of any suitable types of layers (e.g., input layer, one or more hidden layers, output layer, any of which can be convolutional layers, dense layers, non-linearity layers, pooling layers, batch normalization layers, or padding layers). As another example, a deep learning neural network can include any suitable numbers of neurons in various layers (e.g., different layers can have the same or different numbers of neurons as each other). As yet another example, a deep learning neural network can include any suitable activation functions (e.g., softmax, sigmoid, hyperbolic tangent, rectified linear unit) in various neurons (e.g., different neurons can have the same or different activation functions as each other). As still another example, a deep learning neural network can include any suitable interneuron connections or interlayer connections (e.g., forward connections, skip connections, recurrent connections).

In any case, a deep learning neural network can be configured, as described herein, to receive as input medical images and to produce as output region-wise parameter maps. Accordingly, the inference component can electronically execute the deep learning neural network on the medical image, thereby yielding a set of region-wise parameter maps corresponding to the medical image. More specifically, the inference component 114 can feed the medical image 110 to an input layer of the deep learning neural network, the medical image can complete a forward pass through one or more hidden layers of the deep learning neural network, and an output layer of the deep learning neural network can compute the set of region-wise parameter maps based on activations generated by the one or more hidden layers.

In various aspects, the set of region-wise parameter maps can include any suitable number of region-wise parameter maps. In various instances, a region-wise parameter map can be any suitable electronic data (e.g., a vector, a matrix, a tensor) that indicates, specifies, or otherwise represents parameters (e.g., scalar coefficients having any suitable magnitudes) that respectively correspond (e.g., in one-to-one fashion) to the plurality of regions. In other words, a region-wise parameter map can contain, include, comprise, or consist of one unique or distinct parameter (e.g., one scalar coefficient) per unique or distinct region of the medical image. Contrast this with a pixel-wise or voxel-wise parameter map, which would instead indicate, specify, or otherwise represent parameters that respectively correspond to the pixels or voxels of the medical image (e.g., which would instead have one unique or distinct parameter per each unique or distinct pixel or voxel of the medical image). That is, a region-wise parameter map that corresponds to the medical image can have fewer parameters (e.g., can have a smaller dimensionality) than a pixel-wise or voxel-wise parameter map that corresponds to the medical image.

As a non-limiting example, suppose that the medical image is a 200-by-200 array of pixels, and suppose that each disjoint 10-by-10 block of pixels is considered a region of the medical image. In such case, the medical image can have 40,000 total pixels (e.g., 200×200=40,000), and the medical image can have 400 total regions (e.g., since each region can be a disjoint 10-by-10 block of pixels, there can be 20 rows and 20 columns of such 10-by-10 blocks in the medical image; 20×20=400). Accordingly, a pixel-wise parameter map in such case would be a vector, matrix, or tensor having 40,000 parameters (e.g., one per pixel), whereas a region-wise parameter map in such case would instead be a vector, matrix, or tensor having only 400 parameters (e.g., one per region). That is, in this non-limiting example, such region-wise parameter map can have two orders of magnitude fewer parameters than the pixel-wise parameter map.

Because a region-wise parameter map corresponding to the medical image can have fewer parameters (e.g., multiple orders of magnitude fewer parameters, in some cases) than a pixel-wise or voxel-wise parameter map corresponding to the medical image, the set of region-wise parameter maps can likewise collectively have fewer parameters (e.g., multiple orders of magnitude fewer parameters, in some cases) than an analogous set of pixel-wise or voxel-wise parameter maps. Accordingly, because the deep learning neural network can be configured to output the set of region-wise parameter maps, the deep learning neural network can have fewer layers or neurons (e.g., multiple orders of magnitude fewer layers or neurons, in some cases), as compared to a situation in which the deep learning neural network were instead configured to generate an analogous set of pixel-wise or voxel-wise parameter maps. In other words, the footprint of the deep learning neural network can be reduced (e.g., by multiple orders of magnitude, in some cases) by configuring the deep learning neural network to output the set of region-wise parameters instead of an analogous set of pixel-wise or voxel-wise parameter maps.

In various embodiments, a transformation component 116 of the computerized tool 100 can electronically generate a transformed version of the medical image by feeding the medical image and the set of region-wise parameter maps to an analytical transformation function. More specifically, the analytical transformation function can include any suitable number of any suitable types of mathematical operators (e.g., polynomial operators, logarithmic operators, exponential operators, trigonometric operators) that can be combined in any suitable fashion (e.g., that can be combined multiplicatively or additively). Regardless of the specific mathematical operators implemented, the analytical transformation function can take as arguments any given pixel or voxel of the medical image as well as, from each of the set of region-wise parameter maps, a parameter corresponding to whatever region to which the given pixel or voxel is assigned, and the analytical transformation function can produce as output a transformed pixel or voxel. In other words, the analytical transformation function can update the value of any pixel or voxel of the medical image, based on the current value of the pixel or voxel and further based on one parameter from each of the set of region-wise parameter maps. In any case, the analytical transformation function can be applied in this fashion to each pixel or voxel of the medical image, thereby yielding the transformed version of the medical image. Note that this can cause the transformed version of the medical image to have the same format, size, or dimensionality (e.g., the same number or arrangement of pixels or voxels) as the medical image itself. In other words, the analytical transformation function can change the intensity values of the pixels or voxels of the medical image, but can leave unchanged the positions, locations, or arrangement of the pixels or voxels of the medical image.

In various embodiments, a display component of the computerized system 100 can electronically render, on any suitable electronic display (e.g., computer screen, computer monitor, graphical user-interface), the transformed version of the medical image. Thus, a user, technician, or medical professional can visually inspect or view the transformed version of the medical image as rendered on the electronic display, which can aid the user, technician, or medical professional in making a diagnosis or prognosis. Furthermore, in various aspects, a display component 120 can electronically render, on an electronic display, any of the set of region-wise parameter maps. Accordingly, a user, technician, or medical professional can visually inspect such region-wise parameter maps, which can also aid in making a diagnosis or prognosis.

To help cause the set of region-wise parameter maps to be accurate or correct, the deep learning neural network can first undergo any suitable type or paradigm of training (e.g., supervised training, unsupervised training, reinforcement learning). Accordingly, in various aspects, the receiving component 106 can receive, retrieve, or access a training dataset, and the computerized system 100 can comprise a training component (not shown) that can train the deep learning neural network on a training dataset.

In various aspects, the training dataset can comprise a plurality of training medical images. In various instances, a training medical image can have the same size, format, or dimensionality (e.g., the same number or arrangement of pixels or voxels) as the medical image discussed above. For example, if the medical image is a two-dimensional pixel array that depicts an anatomical structure of a medical patient, then each training medical image can likewise be a two-dimensional pixel array that depicts a respective anatomical structure of a respective medical patient. As another example, if the medical image is a three-dimensional voxel array that depicts an anatomical structure of a medical patient, then each training medical image can likewise be a three-dimensional voxel array that depicts a respective anatomical structure of a respective medical patient.

In any case, each training medical image can be considered as corresponding to the plurality of regions discussed above. That is, the pixels or voxels of each training medical image can be considered as being allocated, divided, or otherwise assigned among the same number of regions as the pixels or voxels of the medical image discussed above. For example, suppose that the pixels or voxels of the medical image discussed above are allocated among h regions for any suitable positive integer h>1. In such case, the pixels of voxels of each training medical image can likewise be allocated among such h regions. That is, the medical image can be considered as having a first region, and each training medical image can also be considered as having a respective first region. Similarly, the medical image can be considered as having an h-th region, and each training medical image can also be considered as having a respective h-th region.

Note that, in some instances, the regions of any given training medical image can have identically positioned pixels or voxels as respective regions of the medical image discussed above. For example, if a g-th region of the medical image comprises the pixels that are located in rows i to j and in columns k to/of the medical image for any suitable positive integers g≤h, i<j, and k<l, then the g-th region of the given training medical image can likewise comprise the pixels that are located in rows i to j and in columns k to/of that given training medical image.

However, note that, in other instances, the regions of any given training medical image can have non-identically positioned pixels or voxels as respective regions of the medical image discussed above. For example, if the g-th region of the medical image comprises all pixels of the medical image that are within a given intensity bin, then the g-th region of the given training medical image can likewise comprise all pixels of that given training medical image that are within that given intensity bin. But, because the intensity value distribution of the medical image can differ from the intensity distribution of that given training medical image, the pixels of that given training medical image that fall within that given intensity bin might be in different locations as compared to the pixels of the medical image that fall within that given intensity bin. Indeed, a different number of pixels of the given training medical image might fall within that given intensity bin as compared to the pixels of the medical image.

As another example, if the g-th region of the medical image comprises all pixels of the medical image that belong to a particular tissue type, then the g-th region of the given training medical image can likewise comprise all pixels of that given training medical image that belong to that particular tissue type. But, because the anatomical structures depicted by the medical image can differ from those depicted by the given training medical image, the pixels of that given training medical image that belong to that particular tissue type might be in different locations as compared to the pixels of the medical image that belong to that specific tissue type. Indeed, a different number of pixels of the given training medical image might belong to that particular tissue type as compared to the pixels of the medical image.

In any case, the training dataset can comprise the plurality of training medical images. In various aspects, the training dataset can comprise a plurality of sets of ground-truth region-wise parameter maps that respectively correspond to the plurality of training medical images. In various instances, a set of ground-truth region-wise parameter maps can have the same size, format, or dimensionality as the set of region-wise parameter maps discussed above. In other words, a set of ground-truth region-wise parameter maps can be considered as indicating or representing the correct or accurate region-wise parameter maps that are known or deemed to correspond to a respective training medical image.

In various cases, the training dataset can comprise a plurality of ground-truth transformed medical images that respectively correspond to the plurality of training medical images. In various aspects, a ground-truth transformed medical image can have the same size, format, or dimensionality (e.g., the same number or arrangement of pixels or voxels) as the transformed version of the medical image discussed above. In other words, each ground-truth transformed medical image can be considered as indicating or representing a transformed version (e.g., tissue-equalized version, brightness-contrast-enhanced version, denoised-version, modality-modified version) of a respective training medical image, which transformed version is known or deemed to be correct or accurate.

In various aspects, the training component can perform supervised training on the deep learning neural network, based on the training dataset. Prior to the start of such supervised training, the trainable internal parameters (e.g., weights, biases, convolutional kernels) of the deep learning neural network can be randomly initialized.

In various aspects, the training component can select from the training dataset any suitable training medical image, any suitable set of ground-truth region-wise parameters corresponding to such selected training medical image, and any suitable ground-truth transformed medical image corresponding to such selected training medical image. In various instances, the training component can feed the selected training medical image to the deep learning neural network, which can cause the deep learning neural network to produce a first output. For example, the training component can feed the training medical image to an input layer of the deep learning neural network, the training medical image can complete a forward pass through one or more hidden layers of the deep learning neural network, and an output layer of the deep learning neural network can calculate the first output based on activations from the one or more hidden layers. Note that, in various cases, the size, format, or dimensionality of the first output can be controlled or otherwise determined by the number or arrangement of neurons in the output layer (e.g., the first output can be forced to have a desired size, format, or dimensionality, by adding neurons to or removing neurons from the output layer of the deep learning neural network).

In various aspects, the first output can be considered as the set of predicted or inferred region-wise parameter maps that the deep learning neural network believes should correspond to the selected training medical image. In contrast, the selected set of ground-truth region-wise parameter maps can be considered as the correct or accurate region-wise parameter maps that are known or otherwise deemed to correspond to the selected training medical image. Note that, if the deep learning neural network has so far undergone no or little training, then the first output can be highly inaccurate (e.g., can be very different from the selected set of ground-truth region-wise parameter maps).

In various instances, the training component can generate a second output, by feeding both the selected training medical image and the first output to the analytical transformation function. More specifically, the second output can be considered as a predicted or inferred transformed version (e.g., predicted or inferred tissue-equalized version, predicted or inferred brightness-contrast-enhanced version, predicted or inferred denoised version, predicted or inferred modality-modified version) of the selected training medical image. In contrast, the selected ground-truth transformed medical image can be considered as the correct or accurate transformed version (e.g., correct or accurate tissue-equalized version, correct or accurate brightness-contrast-enhanced version, correct or accurate denoised version, correct or accurate modality-modified version) that is known or otherwise deemed to correspond to the selected training medical image. Note that, if the deep learning neural network has so far undergone no or little training, then the second output can be highly inaccurate (e.g., can be very different from the selected ground-truth transformed medical image).

In various aspects, the training component can compute any suitable error or loss (e.g., mean absolute error (MAE), mean squared error (MSE), cross-entropy) between the first output and the selected set of ground-truth region-wise parameter maps. Likewise, the training component can compute any suitable error or loss (e.g., MAE, MSE, cross-entropy) between the second output and the selected ground-truth transformed medical image. Accordingly, the training component can update the trainable internal parameters (e.g., weights, biases, convolutional kernels) of the deep learning neural network by performing backpropagation (e.g., stochastic gradient descent) driven by such computed errors or losses.

In various instances, such supervised training procedure can be repeated for each training medical image in the training dataset, with the result being that the trainable internal parameters of the deep learning neural network can become iteratively optimized to accurately generate region-wise parameter maps for inputted medical images. In various cases, the training component can implement any suitable training batch sizes, any suitable training termination criteria, or any suitable error, loss, or objective functions.

Note that, in some aspects, the training dataset can lack the plurality of sets of ground-truth region-wise parameter maps. In such case, there can be no selected set of ground-truth region-wise parameter maps, but there can still be the selected ground-truth transformed medical image. Accordingly, backpropagation can be driven by any computed errors or losses between the second output and the selected ground-truth transformed medical image. Conversely, note that, in other aspects, the training dataset can lack the plurality of ground-truth transformed medical images. In such case, there can be no selected ground-truth medical image, but there can still be the selected set of ground-truth region-wise parameter maps. Accordingly, backpropagation can be driven by any computed errors or losses between the first output and the selected set of ground-truth region-wise parameter maps (e.g., in such case, there can be no need to apply the analytical transformation function during training).

Various embodiments described herein can be employed to use hardware or software to solve problems that are highly technical in nature (e.g., to facilitate improved deep learning image processing), that are not abstract and that cannot be performed as a set of mental acts by a human. Further, some of the processes performed can be performed by a specialized computer (e.g., a deep learning neural network having trainable internal parameters such as convolutional kernels) for carrying out defined acts related to improved deep learning image processing. For example, such defined acts can include: accessing, by a device operatively coupled to a processor, a medical image, wherein pixels or voxels of the medical image are allocated among a plurality of regions; generating, by the device and via execution of a deep learning neural network on the medical image, a set of region-wise parameter maps, wherein a region-wise parameter map consists of one predicted parameter per region of the medical image; generating, by the device, a transformed version of the medical image by feeding the set of region-wise parameter maps to an analytical transformation function; and rendering, by the device, the transformed version of the medical image on an electronic display.

Such defined acts are not performed manually by humans. Indeed, neither the human mind nor a human with pen and paper can electronically access a medical image (e.g., a CT scanned image, an MRI scanned image, an X-ray scanned image), electronically execute a deep learning neural network on the medical image so as to generate region-wise parameter maps (as opposed to pixel-wise or voxel-wise parameter maps), electronically use the region-wise parameter maps to generate a transformed version the medical image, and electronically display such transformed version of the medical image on a computer screen. Indeed, a deep learning neural network is an inherently-computerized construct that simply cannot be implemented in any way by the human mind without computers. Similarly, medical images are inherently computerized constructs that are generated or captured by electronic medical hardware (e.g., CT scanners, MRI scanners, X-ray scanners, PET scanners, ultrasound scanners) and not in any way by the human mind without computers. Accordingly, a computerized tool that can train or execute a deep learning neural network to produce transformed versions of medical images is likewise inherently-computerized and cannot be implemented in any sensible, practical, or reasonable way without computers.

Furthermore, various embodiments described herein can control real-world tangible devices based on the disclosed teachings. For example, various embodiments described herein can electronically execute (or train) real-world deep learning neural networks on real-world medical images (e.g., CT images, MRI images, X-ray images, PET images, ultrasound images), and can electronically render any results produced by such real-world deep learning neural networks on real-world computer screens.

It should be appreciated that the herein figures and description provide non-limiting examples of various embodiments and are not necessarily drawn to scale. Also the terms AI/NN model deep learning optimization component, AI deep learning, AI neural network, neural network and deep learning may be used interchangeably but reflect the same concept.

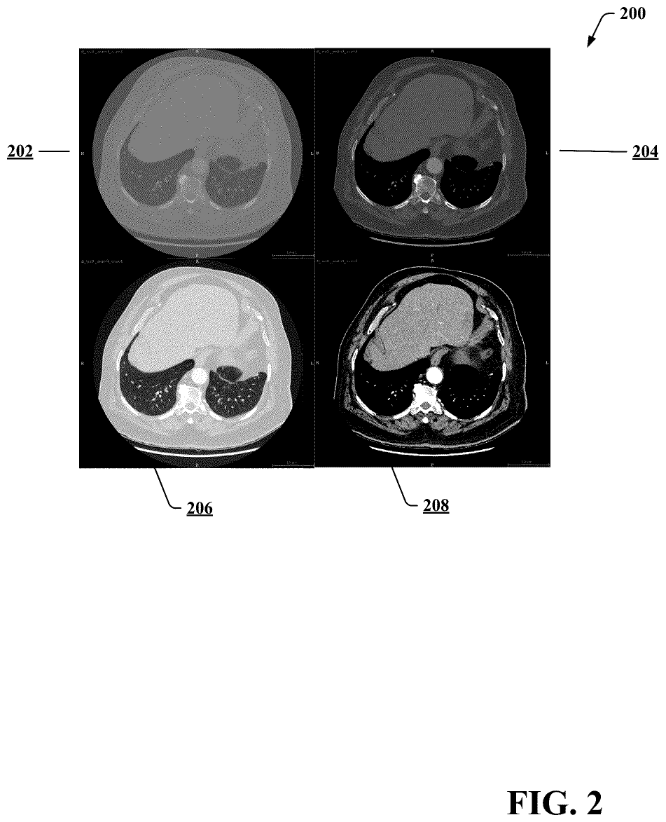

FIG. 2 illustrates an example of various images with different brightness and contrast in accordance with one or more embodiments described herein. The various images (202,204,206,208) reveal how a broader spectrum of enhancement can show greater detail and define structures with heightened definition. However, as one of the images may have an emphasis on 1 organ, it diminishes the quality of the remaining content when analyzing the image.

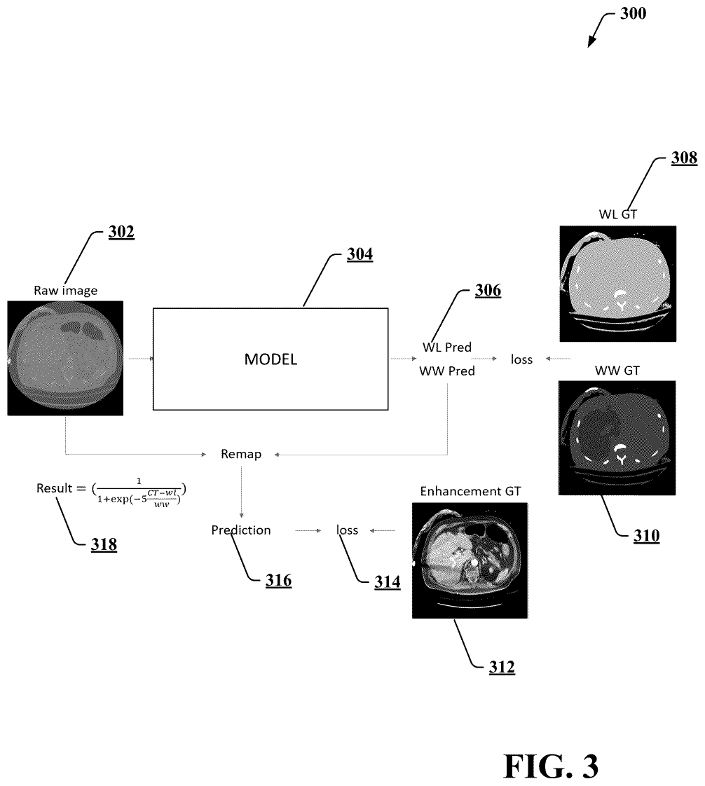

FIG. 3. illustrates an example of the image optimization process in accordance with one or more embodiments described herein. For this innovation, the basic process starts with an image 302 which is sent into model 304 to start the transformation. Any segmentation is avoided in inference time, and it's only considered in training phase for annotation. Therefore, the annotation effort is minimized to just define preferred organ appearance, e.g., WL (Window Level)/WW (Window Width) per organ. In addition, because the AI model generates per pixel maps in regression manner, rather than segmentation masks, the AI model training is easier than conventional segmentation-based approaches. Predicted WW/WL 306 is the output and there is a comparison with the ground truth WL GT 308 and WW GT 310 to gage the difference and the loss function. The remapping function 318 is based on a non-linear transformation and this function will provide a prediction per organ WW/WL which is based on parameters that can regenerate the raw image to the desired image. The comparison between the prediction 316 and the enhanced GT 312 image is the outcome with the loss function 314 determining the acceptability. For this innovation, the inventors map the input to the function and the function to the output. Having an in between function allows the process to reduce issues with artifacts that direct mapping would introduce.

Optimized parameters can also be important in optimizing organ imaging. In organ imaging systems, kilovoltage (kV) settings play a crucial role in determining image quality and patient dose. High kV Settings have a typical range of 120-140 kV and provide advantages such as reduced patient dose as higher kV settings require less radiation to penetrate a body. Also, another benefit is better penetration which is effective for imaging larger patients. Low kV settings have a typical range of 80-100 kv and provide better differentiation between tissues, especially useful for detecting small or subtle lesions. The choice between high and low kV settings depends on the specific diagnostic task, patient size, and the organ being imaged. For instance, low kV settings are often used for chest X-rays to enhance contrast, while high kV settings might be preferred for abdominal CT scans to reduce dose. In organ imaging, milliampere-seconds (mAs) are a key parameter that affects image quality and patient dose. The mAs value is a product of a tube current (in milliamperes, mA) and the exposure time in seconds. Higher mAs can increase the number of X-ray photons, leading to better image quality with less noise. However, it also increases the radiation dose to the patient. While lower mAs can reduce the number of X-ray photons, which can result in noisier images but decreases the radiation dose to the patient. The goal is to find the optimal balance between image quality and patient dose. This often involves adjusting the mAs settings based on the specific imaging task, patient size, and the organ being imaged. In organ imaging, particularly in CT (computed tomography) scans, pitch is also an important parameter that affects both image quality and patient dose. Pitch is defined as the ratio of the table travel distance during one complete gantry rotation to the total width of the X-ray beam collimation 1. The optimal pitch depends on the specific imaging task and the balance between image quality and patient dose. Gantry rotation speed is a critical parameter in CT (computed tomography) imaging that affects both image quality and patient dose. The speed at which the CT scanner's gantry rotates around the patient impact on image quality. Faster gantry rotation speeds can improve temporal resolution, reducing motion artifacts, especially in imaging moving organs like the heart.

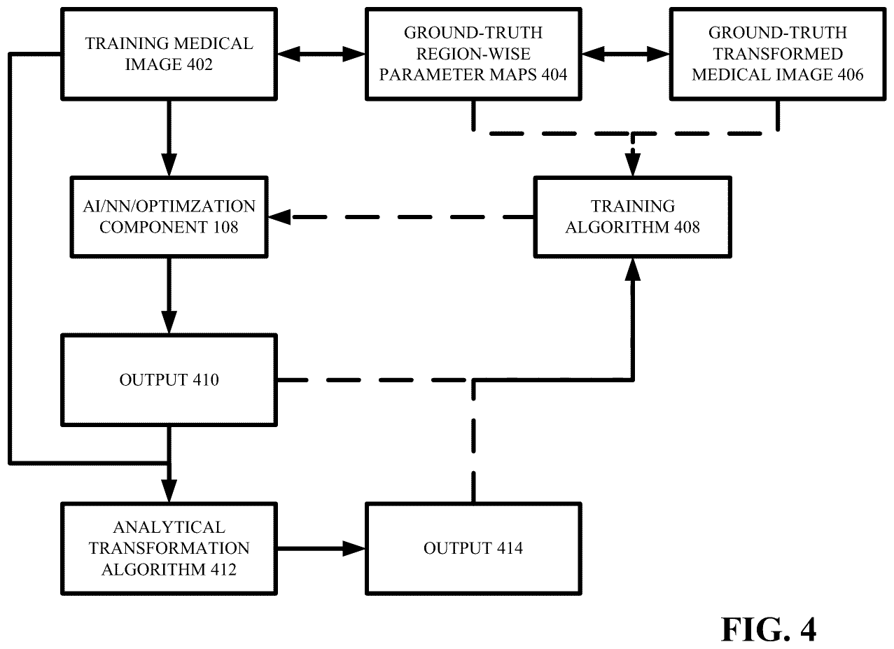

FIG. 4 illustrates an example, non-limiting block diagram showing how an AI/NN deep learning neural network can be trained on a training dataset with reference to ground truth in accordance with one or more embodiments described herein. An important aspect in the innovation is the quality of the training data and the training process itself. A lack of rigorous training will lead to poor image results and may cause significant delays in accurate performance. This can be corrected by new comprehensive data for training but can consume many resources and time. In various aspects, the training algorithm 408 can, prior to beginning such training, initialize in any suitable fashion (e.g., random initialization) the trainable internal parameters (e.g., convolutional kernels, weight matrices, bias values) of the AI/NN deep learning neural network 108.

In various instances, a training component 408 can select from a recent training dataset of a training medical image 402, a set of ground-truth region-wise parameter maps 404 that corresponds to a training medical image 402, and a ground-truth transformed medical image 406 that corresponds to the training medical image 402. The “ground truth” refers to the definitive and accurate information about a patient's condition or the characteristics of a particular medical image. It serves as the reference standard against which the performance of imaging algorithms or diagnostic methods is evaluated. Ground truth is typically established through rigorous and reliable means, such as histopathological examination, surgical findings, or long-term clinical follow-up. In various cases, as shown, a training component 408 can execute on an AI/NN deep learning neural network 108 on the training medical image 402, thereby causing an AI/NN deep learning neural network 108 to produce an output 410. More specifically, a training component 408 can feed a training medical image 402 to an input layer of an AI/NN deep learning neural network 108, the training medical image 402 can complete a forward pass through one or more hidden layers of an AI/NN deep learning neural network 108, and an output layer of the AI/NN deep learning neural network 108 can compute the output 410 based on activations generated by the one or more hidden layers of the AI/NN deep learning neural network 108.

Note that, in various cases, the size, format, or dimensionality of the output 410 can be controlled or otherwise determined by the number of arrangement of neurons (or by characteristics of other internal parameters such as convolutional kernels) that are in the output layer of an AI/NN deep learning neural network 108. That is, the output 410 can be forced to have a desired size, format, or dimensionality, by controllably adding, removing, or adjusting neurons (or other internal parameters such as convolutional kernels) to, from, or in the output layer of the AI/NN deep learning neural network 108.

In various aspects, the output 410 can be considered as the p predicted or inferred region-wise parameter maps that an AI/NN deep learning neural network 108 believes should correspond to the training medical image 402. In contrast, the set of ground-truth region-wise parameter maps 404 can be considered as the p correct or accurate region-wise parameter maps that are known or deemed to correspond to the training medical image 402. Note that, if the AI/NN deep learning neural network 108 has so far undergone no or little training, then the output 410 can be highly inaccurate (e.g., can be quite different from the set of ground-truth region-wise parameter maps 404).

In various instances, a training algorithm 408 can feed the output 410 and the training medical image 402 to the analytical transformation algorithm 412, thereby yielding an output 414. Accordingly, the output 414 can be considered as the predicted or inferred transformed version (e.g., predicted or inferred tissue-equalized version, predicted or inferred brightness-contrast-enhanced version, predicted or inferred denoised version, predicted or inferred modality-modified version) of the training medical image 402. In contrast, the ground-truth transformed medical image 406 can be considered as the known correct or accurate transformed version (e.g., correct or accurate tissue-equalized version, correct or accurate brightness-contrast-enhanced version, correct or accurate denoised version, correct or accurate modality-modified version) of the training medical image 402. As above, note that, if the AI/NN deep learning neural network 108 has so far undergone no or little training, then the output 414 can be highly inaccurate (e.g., can be quite different from the ground-truth transformed medical image 406).

In various aspects, a training component 408 can compute any suitable errors or losses (e.g., MAE, MSE, cross-entropy) between the output 410 and the set of ground-truth region-wise parameter maps 404. Likewise, in various instances, a training component 408 can compute any suitable errors or losses (e.g., MAE, MSE, cross-entropy) between the output 414 and the ground-truth transformed medical image 406. In various cases, the training component 408 can incrementally update, via backpropagation, the trainable internal parameters (e.g., convolutional kernels, weights, biases) of an AI/NN deep learning neural network 108, based on such computed errors or losses.

In various aspects, the training component 408 can repeat such execution and update procedure for each training medical image in a training dataset. This can ultimately cause the trainable internal parameters (e.g., convolutional kernels, weights, biases) of an AI/NN deep learning neural network 108 to become iteratively optimized to accurately generate region-wise parameter maps for inputted medical images. In various instances, the training component 408 can implement any suitable training batch sizes, any suitable training termination criteria, or any suitable error, loss, or objective functions.

In some cases, it may be possible for a training dataset to lack the plurality of sets of ground-truth region-wise parameter maps 404. In such case, an AI/NN deep learning neural network 108 can be trained substantially as described with respect to FIG. 4, except that the set of ground-truth region-wise parameter maps 404 can be unavailable. In such case, the training algorithm 408 can refrain from computing an error or loss between the output 410 and the set of ground-truth region-wise parameter maps 404. However, the training component 408 can nevertheless computer an error or loss between the output 414 and the ground-truth transformed medical image 406, and backpropagation can be driven by such error or loss.

In other cases, it may be possible for a training dataset to lack the plurality of ground-truth transformed medical images 406. In such case, an AI/NN deep learning neural network 202 can be trained, except that the ground-truth transformed medical image 406 can be unavailable. In such case, the training algorithm 408 can refrain from computing an error or loss between the output 414 and the ground-truth transformed medical image 406. However, the training component 408 can nevertheless computer an error or loss between the output 410 and the set of ground-truth region-wise parameter maps 404, and backpropagation can be driven by such error or loss. Note that, in such cases, it can be unnecessary for the training component 408 to apply an analytical transformation function to the output 410. It should be noted there are many ways to train an AI/NN deep learning system and the content discussed are just various examples and may or may not be part of the embodiments. The system is trained to learn what an organ is completely during the training process and does not play a role at inference. The organs are learned by the system over training and time and the optimized image. All segmentation occurs at training, not at inference.

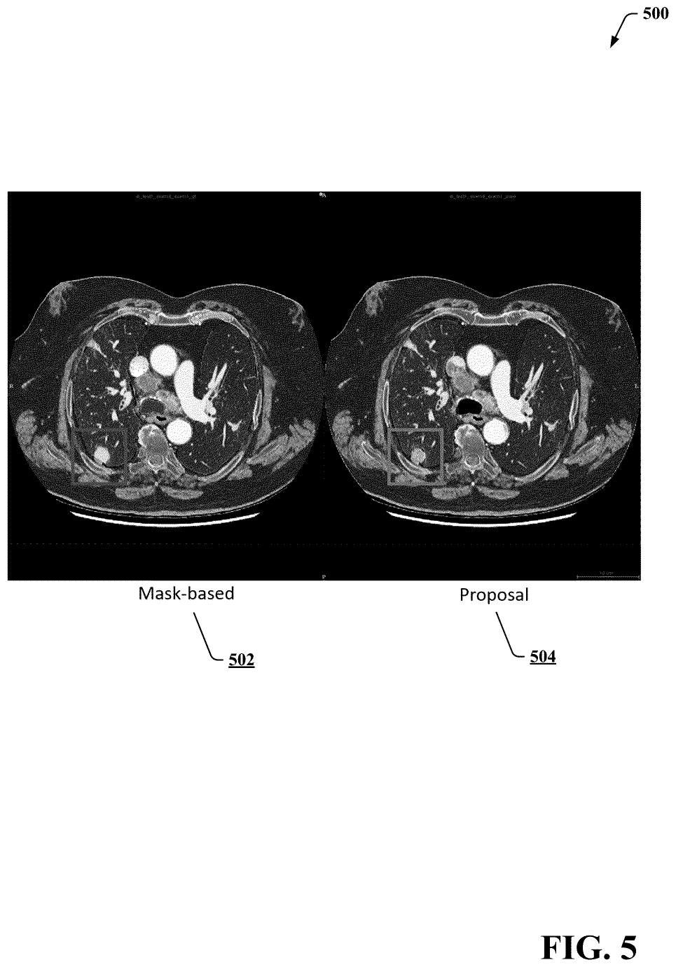

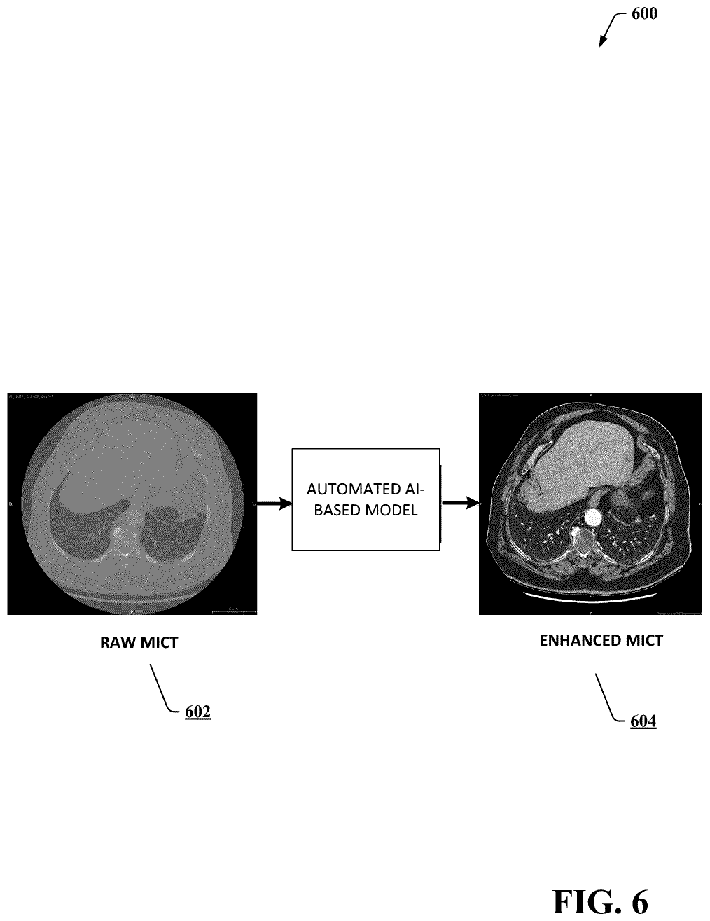

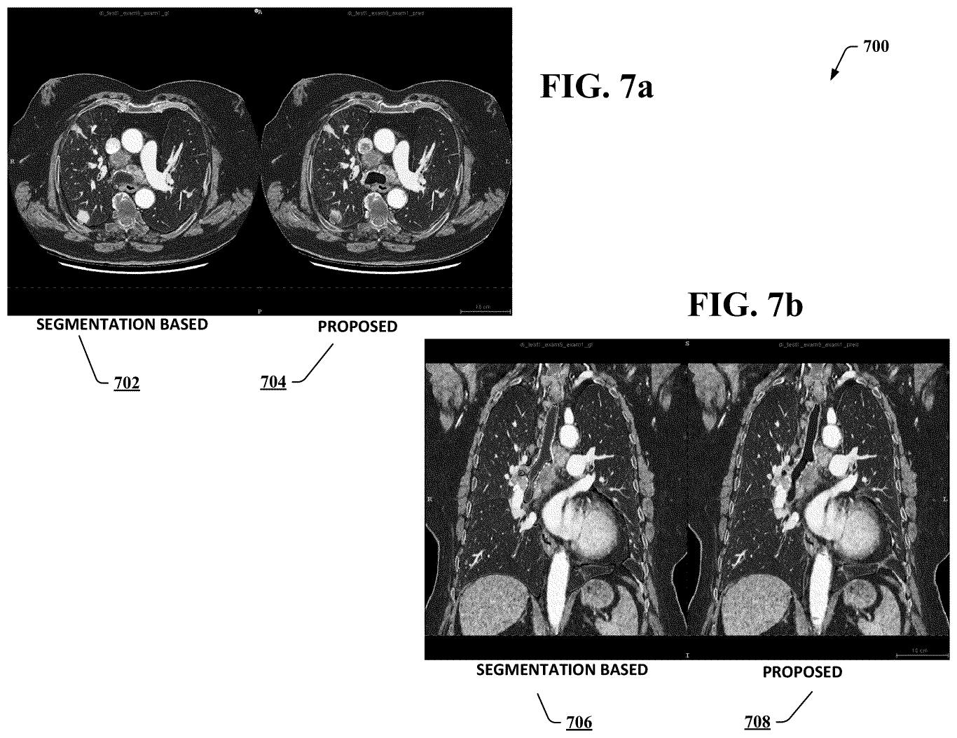

FIG. 5-7b illustrate examples of current segmentation-based images versus images processed by the invention in accordance with one or more embodiments described herein. For FIG. 5 the enhanced technology image reveals incredible detail which is evident in the inferior aspect of the image highlighting vertebral body structure 504 and its relationship to adjacent anatomy-compared to the current segmentation-based image 502. For FIG. 6, we observe obvious differences. It is clear that the enhanced image 604 technology shows greater detail then the raw 602 and is, therefore, more likely to reveal even subtle changes that may suggest early disease or abnormalities. FIGS. 7a and 7b contain 2 sets of images. Again, this comparison emphasizes value of a broader grey scale. With more levels of enhancement in 704, the detail is greater and can serve as an invaluable tool in identifying early or subtle pathological findings compared to current solution 702. FIG. 7b reflects a similar outcome as 708 reflects a much clearer picture then 706.

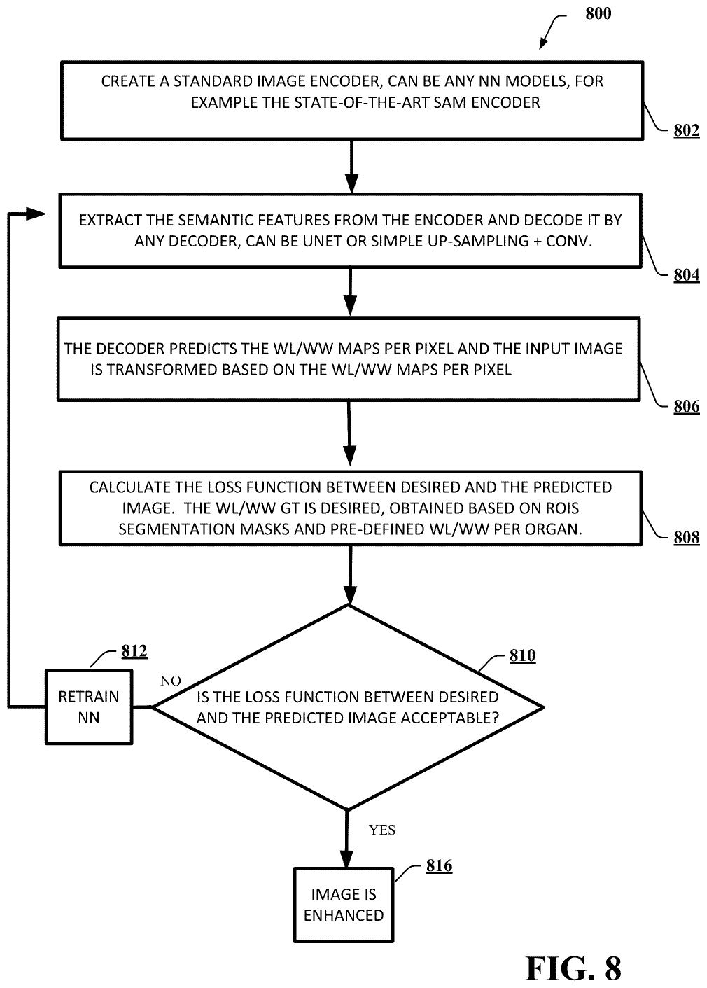

FIG. 8 illustrates a flow diagram of the image optimization process, non-limiting computer-implemented method that facilitates enhanced image processing in accordance with one or more embodiments described herein. The basic technology sequence starts with 802, where at first is to create a standard image encoder, can be any NN models, for example the state-of-the-art SAM encoder. An encoder typically refers to a component or algorithm that is used to convert raw data or images into a different representation. This process is commonly part of the image reconstruction or processing pipeline in medical imaging systems. The term “encoder” can have different meanings depending on the specific imaging modality or technique. In some cases, an encoder may be used for data compression, where the raw image data is transformed into a more compact representation without losing critical information. This can be important for reducing storage requirements and speeding up transmission of medical images. An encoder can also be part of a feature extraction process as identified in 804. In this context, the encoder transforms the input data into a set of representative features that capture important information about the underlying structures in the medical images. This feature representation can be used for tasks such as image classification, segmentation, or other analysis. In medical imaging, an encoder might be involved in signal processing tasks. For example, in computed tomography (CT) imaging, an encoder may be used to convert raw X-ray measurements into an image representation through processes like back projection and filtering. With the rise of deep learning and neural networks in medical imaging, the term “encoder” is often associated with the encoding part of an autoencoder architecture. An autoencoder is a type of neural network that consists of an encoder and a decoder. The encoder compresses the input data into a latent space representation, and the decoder reconstructs the original input from this representation. It can be decoded 804 by any decoder, can be UNet or simple Up-sampling+Conv.

The decoder is the counterpart of the encoder. It takes the compressed or latent representation produced by the encoder and reconstructs the original input data. In the context of medical imaging, the decoder aims to generate an output that closely resembles the input image.

At 806, the decoder predicts the WL/WW maps per pixel and the input image is transformed based on the WL/WW maps per pixel. It's important to note that this functionality is implemented an a previous “Remapping” invention, and that this innovation is built upon that. The specific role and function of an encoder can vary depending on the imaging modality (e.g., CT, MRI, ultrasound) and the specific task or application within medical imaging. At 808, a calculation of the loss function between desired and the predicted image is executed. The WL/WW GT is desired, obtained based on ROIs segmentation masks and pre-defined WL/WW per organ. The loss function (also called a cost function or objective function) is a measure of the difference between the predicted output and the actual target—in this case the images. The goal during the training of a neural network is to minimize this loss function. This is a pivotal area and is heavily based on training. Another possible option to consider may be photon-counting computed tomography (PCCT) which is a form of X-ray computed tomography (CT) in which X-rays are detected using a photon-counting detector (PCD) which registers the interactions of individual photons. By keeping track of the deposited energy in each interaction, the detector pixels of a PCD each record an approximate energy spectrum, making it a spectral or energy-resolved CT technique.

At 810, there is a comparison between the predicted image and the actual image and based on the results, additional training 812 may be needed or the image is acceptable 816.

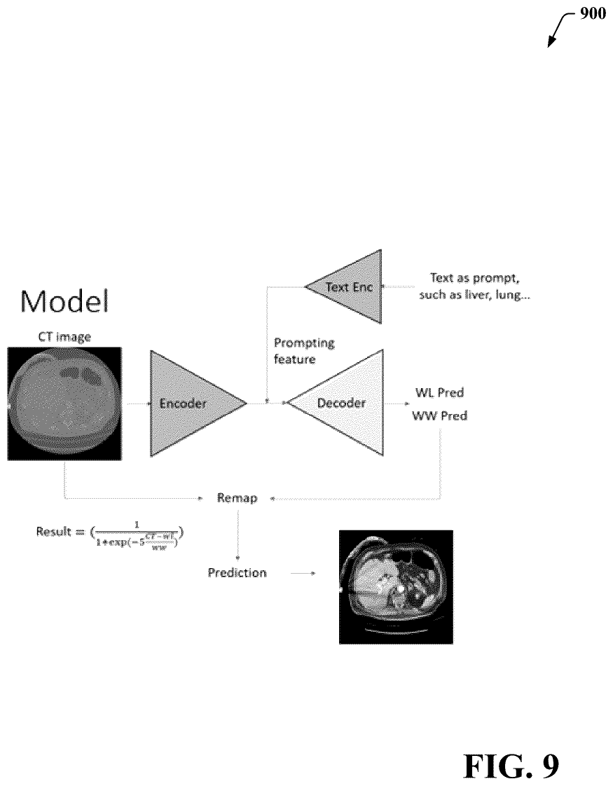

FIG. 9, 900 illustrates an example of the image optimization process using text as a prompt to guide the feature decoding in accordance with one or more embodiments described herein. The training is as follows: the GT are generated based on the interested organs categories, such as a text of [lung, liver, kidney, or any potential organ.] The text is encoded by a pre-trained CLIP model for embedding feature extraction. Then the extracted language feature is fused with image feature for decoding. The generated image is learned by using GT, which enhanced by selected region from text and the loss term can be simple MAE loss.

Although the herein disclosure mainly describes various embodiments as applying to a deep learning AI neural network, this is a mere non-limiting example. In various aspects, the herein-described teachings can be applied to any suitable machine learning models exhibiting any suitable artificial intelligence architectures (e.g., support vector machines, naïve Bayes, linear regression, logistic regression, decision trees, random forest).

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ artificial intelligence to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f(z)=confidence (class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

The herein disclosure describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

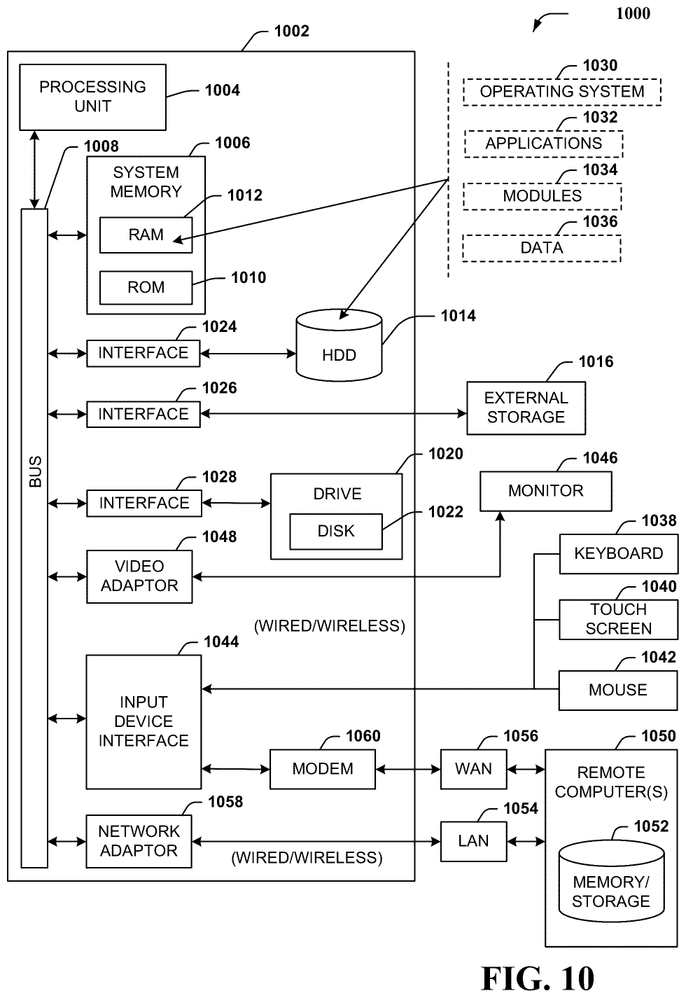

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and a drive 1020, e.g., such as a solid state drive, an optical disk drive, which can read or write from a disk 1022, such as a CD-ROM disc, a DVD, a BD, etc. Alternatively, where a solid state drive is involved, disk 1022 would not be included, unless separate. While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and drive 1020 can be connected to the system bus 1008 by an HDD interface 1024, an external storage interface 1026 and a drive interface 1028, respectively. The interface 1024 for external drive implementations can include at least one or both of Universal Serial Bus (USB) and Institute of Electrical and Electronics Engineers (IEEE) 13104 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For instance with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 13104 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above, such as but not limited to a network virtual machine providing one or more aspects of storage or processing of information. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

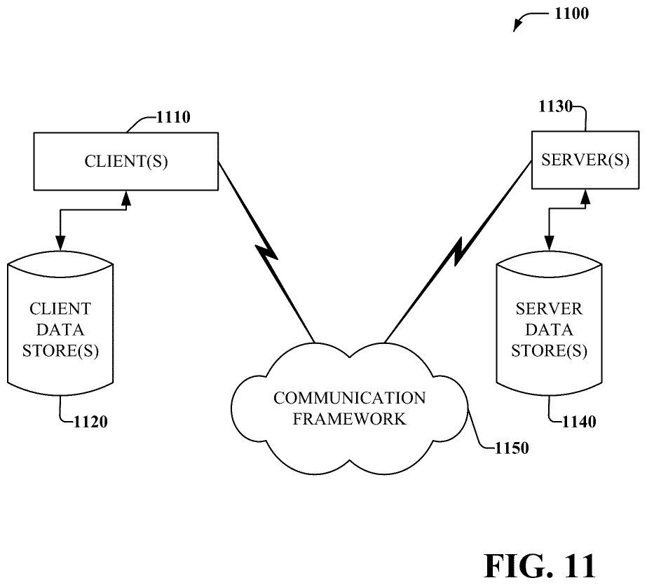

FIG. 11 is a schematic block diagram of a sample computing environment 1100 with which the disclosed subject matter can interact. The sample computing environment 1100 includes one or more client(s) 1110. The client(s) 1110 can be hardware or software (e.g., threads, processes, computing devices). The sample computing environment 1100 also includes one or more server(s) 1130. The server(s) 1130 can also be hardware or software (e.g., threads, processes, computing devices). The servers 1130 can house threads to perform transformations by employing one or more embodiments as described herein, for example. One possible communication between a client 1110 and a server 1130 can be in the form of a data packet adapted to be transmitted between two or more computer processes. The sample computing environment 1100 includes a communication framework 1150 that can be employed to facilitate communications between the client(s) 1110 and the server(s) 1130. The client(s) 1110 are operably connected to one or more client data store(s) 1120 that can be employed to store information local to the client(s) 1110. Similarly, the server(s) 1130 are operably connected to one or more server data store(s) 1140 that can be employed to store information local to the servers 1130.

The present invention may be a system, a method, an apparatus or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations or block diagrams of methods, apparatus (systems), and computer program products according to embodiments of the invention. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a processor that executes computer-executable components stored in a non-transitory computer-readable memory, wherein the computer-executable components comprise:
a receiving component that receives a set of “regions/volume of interest” images containing a plurality of organs; and
an artificial intelligence deep learning neural network model component that automatically processes and enhances the respective images in a locally adaptive way so that at each location the enhanced image is optimized for an organ that is displayed at that location.

2. The system of claim 1, wherein the artificial intelligence deep learning neural network model component predicts window level (WL) and window width (WW) maps per organ of a plurality of identified scanned organs.

3. The system of claim 1, wherein the artificial intelligence deep learning neural network model predicts WL and WW maps using a regression technique.

4. The system of claim 1, wherein the artificial intelligence deep learning neural network model is trained in part by calculating a loss function between a desired organ image and a predicted organ image.

5. The system of claim 1, wherein the plurality of scanned organs respective images of the plurality of organs are obtained using at least one of: single energy computer tomography (CT) or dual-energy computer tomography (CT) or photon counting computing tomography (PCCT).

6. The system of claim 4, wherein the artificial intelligence deep learning neural network model generates the organ-specific optimized views of the respective images based in part of contrast levels and processing parameters.

7. The system of claim 1, wherein the artificial intelligence deep learning neural network model generates an organ specified view of the respected images based in part on comparison to ground truth images.

8. The system of claim 7, wherein ground truth images are generated utilizing optimized acquisition parameters (high and low KV settings, mAmps, pitch, gantry rotation speed, or WL and WW views).

9. The system of claim 6, wherein the artificial intelligence deep learning neural network model employs one or more remapping algorithms to generate the organ specific optimized view of the respective images to be smooth at region transitions and preserve details of a respective organ structure.

10. A computer-implemented method, comprising:
using a processor that executes computer-executable components stored in a non-transitory computer-readable memory, to perform the following acts:
receive a set of “regions/volume of interest” images containing a plurality of organs; and
employ an artificial intelligence deep learning neural network model that automatically processes and enhances the respective images in a locally adaptive way so that at each location the enhanced image is optimized for an organ that is displayed at that location.

11. The method of claim 10, further comprising using the artificial intelligence deep learning neural network model component to predict window level (WL) and window width (WW) maps per organ of a plurality of identified scanned organs.

12. The method of claim 10, further comprising using the artificial intelligence deep learning neural network model to predict WL and WW maps using a regression technique.

13. The method of claim 10, further comprising training the artificial intelligence deep learning neural network model in part by calculating a loss function between a desired organ image and a predicted organ image.

14. The method of claim 10, further comprising obtaining the plurality of scanned organs respective images of the plurality of organs by using at least one of: single energy computer tomography (CT) or dual-energy computer tomography (CT) or photon counting computing tomography (CT).

15. The method of claim 10, further comprising using the artificial intelligence deep learning neural network model to generate the organ-specific optimized views of the respective images based in part of contrast levels and processing parameters.

16. The method of claim 10, further comprising using the artificial intelligence deep learning neural network model to generate an organ specified view of the respected images based in part on comparison to ground truth images.

17. The method of claim 16, further comprising generating the ground truth images utilizing optimized acquisition parameters (high and low KV settings, mAmps, pitch, gantry rotation speed, or WL and WW views).

18. The method of claim 16, wherein the artificial intelligence deep learning neural network model employs one or more remapping algorithms to generate the organ specific optimized view of the respective images to be smooth at region transitions and preserve details of a respective organ structure.

19. A non-transitory machine-readable storage medium, comprising executable instructions that, when executed by a processor, facilitate performance of operations, comprising:
receiving a set of “regions/volume of interest” images, by the processor, containing a plurality of organs; and
employing by the processor, an artificial intelligence deep learning neural network model component that automatically processes and enhances the respective images in a locally adaptive way so that at each location the enhanced image is optimized for an organ that is displayed at that location.

20. The non-transitory machine-readable storage medium of claim 19, further comprising using an artificial intelligence deep learning neural network model to predict window level (WL) and window width (WW) maps per organ of a plurality of identified scanned organs.
